(19) United States
(12) Patent Application Publication
(10) Pub. No.: US 2026/0042713 A1
(43) Pub. Date: Feb. 12, 2026

(54) PROCESS FOR TREATMENT OF A SODIUM SULFATE CONTAINING RESIDUE PROCESS STREAM OF A BATTERY PROCESS

(71) Applicant: Cinis Fertilizer AB, Lund (SE)

(72) Inventor: Jakob Liedberg, Lund (SE)

(73) Assignee: Cinis Fertilizer AB, Lund (SE)

(21) Appl. No.: 18/998,706

(22) PCT Filed: Jun. 20, 2023
(86) PCT No.: PCT/SE2023/050633

§ 371 Date: Jan. 27, 2025

(30) Foreign Application Priority Data
Jul. 28, 2022 (SE) 2250932-7

(51) Int. Cl. C05D 1/02; C01D 5/00; H01M 6/52; H01M 10/54

(52) U.S. Cl. CPC C05D 1/02; C01D 5/00; H01M 6/52; H01M 10/54

(57) ABSTRACT

The present invention relates to a method for producing a potassium sulfate containing fertilizer composition from a sodium sulfate containing residue process stream of a battery production process or a battery recycling process, wherein the residue process stream is provided from the battery production process or the battery recycling process, wherein the residue process stream is obtained from production of batteries comprising at least sodium and iron (Na, Fe) or obtained from recycling of batteries comprising at least sodium and iron (Na, Fe); optionally water is provided; potassium chloride is provided; and a mixture is provided comprising said optional water, potassium chloride and residue process stream, and is allowed to react, wherein potassium sulfate is obtained.

### FIELD OF THE INVENTION

The present invention relates to a process for providing value adding products from a residue process stream from a battery production process.

### BACKGROUND

An increased awareness of climate change and the limited supply of fossil fuels has boosted the search alternative energy sources for e.g., operation of vehicles. The demand for batteries is growing fast. This means also that the emissions, solid and liquid residues from battery production increases. Recycling, and material optimization has thus become a relevant issue in recent years.

Battery manufacturing industry is working continuously to minimize residue provision, and aim to recycle of process essential chemicals like cobalt, lithium and manganese which aid to reduce the facility's operating costs. Residues from a battery manufacturing process may be aqueous wastewater streams, ammonia, n-methyl pyrrolidone, and hazardous waste such as battery metal components. However, as residue streams, especially wastewater streams, may be quite voluminous, reducing the amount of residues and provide value adding components from the streams classified as waste is desirable to improve the overall operation in terms of costs and raw material usage of the battery manufacturing facility, and allowing reuse of the Earth's finite resources. Also, local or national regulations may influence if battery production is allowable in view of residues and emissions provided from the processes especially with regards to emissions to a water recipient. Non-desirable elements like sulfates, and sodium, may be provided in high levels in the battery production, and they negatively influence the residue process streams as they are expensive to dispose of, and if forwarded directly to sewers and/or wastewater treatment plants they put a lot of stress on said downstream processes, and the presence, or prospect of presence, of high amounts of sulfates and sodium would today prevent approval of permits for establishing a battery production facility. Sodium sulfate is a problematic by-product to be handled for battery manufacturers. In view of the volumes produced, the costs for handling sodium sulfate may be substantial, also a lack of addressing chemical handling may prevent a company from receiving needed permits to continue their production or obtain new permits for increase in production or building new production facilities.

Today sodium sulfate present in residue process streams may be rejected e.g., to the wastewater system via drains or sewers, or onto landfills or separated from the residue stream and sold as low-grade chemicals. Residue process streams from a battery production facility containing sodium sulfate mainly originates from the oxidation step of the cathode production. Even if sodium sulfate is considered a waste material, if a use therefore could be provided it could become a valued asset as the sodium sulfate can be present in large amounts. For a battery manufacturing facility handling the obtained sodium sulfate is considered a problem. However, if sodium sulfate could be put to good use it could become a valuable-adding product for the overall process.

A problem with the present residue process streams of battery manufacturing facilities is that possible valuable chemicals are not retrieved or recycled therefrom. In reality, a large amount of chemicals is always discharged to landfill, or disposed of as low-grade chemicals, or sent to wastewater system.

Today also much focus is put on obtaining environmentally sustainable processes and obtaining as much value adding products or recyclable products out of a process as possible, in order to avoid as much waste and losses as possible.

Thus, there is a need to obtain more efficient processes. There is a demand for processes which reduces the need for putting material on landfills and discharging valuable chemicals to wastewater system. There is also a need for providing additional value adding products from waste material from battery production or recycling facilities which improves the economy of the total battery production or recycling facilities.

### SUMMARY

With the present process, high value products are obtainable and at the same time an environmentally more sustainable solution to waste handling is provided. By providing an added-value product that have a demand on the market and may be sold the total economy of a battery production or recycling facility is improved and the recourses of Mother Nature are used with caution. Also, the process enables possibility to meet requirements and legislations related to waste handling for battery manufacturing.

With the invention a huge amount of chemical, namely sodium sulfate, present in the residue process stream can be used and the negative environmental impact from a battery residue process stream can be eliminated. Since a high-grade fertilizer is obtained by the present invention is it also possible to forward the nutrient chemicals to plants, where they are needed, instead of forwarding them out to a drain or sewer, or onto landfills or separated as low-grade chemicals.

The scope of the present invention is in accordance with the appended claims.

The present invention relates to a method for producing a potassium sulfate, K₂SO₄, containing fertilizer composition from a battery production process or a battery recycling process. The present invention is directed to a method for producing a potassium sulfate containing fertilizer composition from a sodium sulfate containing residue process stream of a battery production process, wherein the residue process stream is provided from the battery production process, wherein the residue process stream is obtained from batteries comprising at least sodium and iron (Na, Fe); optionally water is provided; potassium chloride is provided; and a mixture is provided comprising said optional water, potassium chloride and residue process stream, and is allowed to react, wherein potassium sulfate is obtained. The present invention is directed to a method for producing a potassium sulfate containing fertilizer composition from a sodium sulfate containing residue process stream of a battery production process or a recycling process, wherein the residue process stream is provided from the battery production process or a recycling process, wherein the residue process stream is obtained from production of batteries comprising at least sodium and iron (Na, Fe) or obtained from recycling of batteries comprising at least sodium and iron (Na, Fe); optionally water is provided; potassium chloride is provided; and a mixture is provided comprising said optional water, potassium chloride and residue process stream, and is allowed to react, wherein potassium sulfate is obtained. The residue process stream may be provided from processes in the production of sodium and iron and optionally cyanide containing batteries, or may be provided from recycling processes of batteries containing sodium and iron and optionally cyanide.

It is provided a method for producing a potassium sulfate containing fertilizer composition from a sodium sulfate containing residue process stream of a battery production process, wherein
the residue process stream is provided from the battery production process, wherein the residue process stream is obtained from batteries comprising at least sodium and iron (Na, Fe);
optionally water is provided;
potassium chloride is provided; and
a mixture is provided comprising said optional water, potassium chloride and residue process stream, and is allowed to react, wherein potassium sulfate is obtained. The batteries may additionally contain cyanide.

According to one embodiment the potassium chloride and the residue process stream are provided in any order or simultaneously to of provide said mixture. Preferably the optional water and residue process stream is added before the potassium chloride.

According to one embodiment acid is admixed to the mixture. Preferably sulfuric acid and/or hydrochloric acid is used, more preferably sulfuric acid. Preferably the acid is added before the addition of the potassium chloride. Such addition may be made to adjust the pH of the mixture.

According to one embodiment the residue process stream is contacted with the potassium chloride.

According to one embodiment sodium hydroxide and/or potassium hydroxide is added to the water, potassium chloride, and residue process stream mixture. This is done to adjust the pH, e.g., if acid has been added.

According to one embodiment glaserite is obtained by the reaction of the water, the potassium chloride and the residue process stream, said glaserite is removed and admixed with additional potassium chloride and/or is leached with water to provide potassium sulfate. The potassium sulfate may then be removed for further use or sold. It is to be noted that the admixing of potassium chloride and leaching with water may be done in any order. However, in a preferred embodiment the reaction with potassium chloride is performed first, followed by leaching with water.

According to one embodiment the remaining mixture after removal of potassium sulfate is concentrated, where after any sodium chloride present is removed for further use.

According to one embodiment the removed sodium chloride is forwarded to a cell membrane process converting it to sodium hydroxide, hydrogen and chlorine.

The present invention also relates to use of the present process for the production of a fertilizer comprising potassium sulfate.

### DESCRIPTION OF THE DRAWINGS

FIG. 1. shows a figure outlining a process according to one embodiment of the present invention, for producing potassium sulfate from Na₂SO₄ derived from a Prussian white production process.

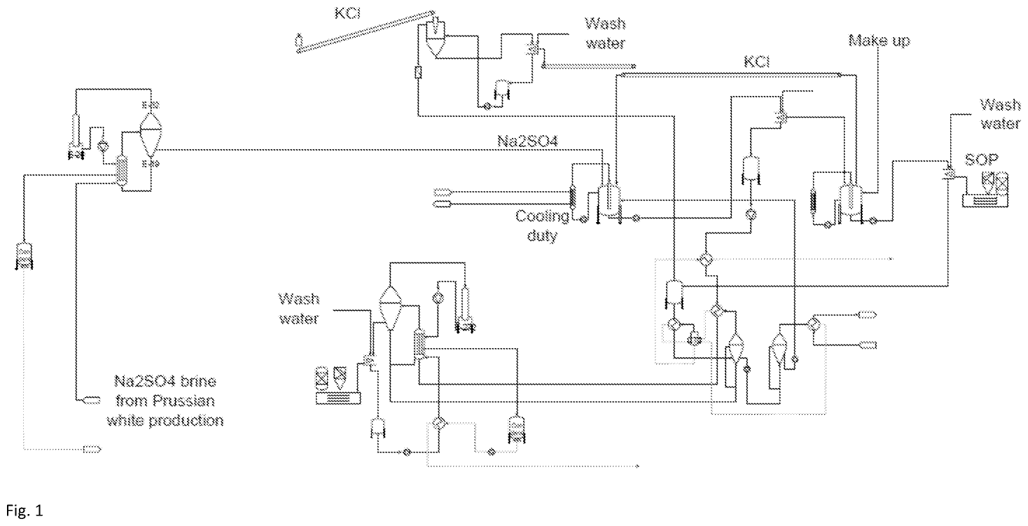

FIG. 2. shows a block diagram for a process for producing a cathode material, and the Na₂SO₄ residual waste stream coming out of Prussian white production.

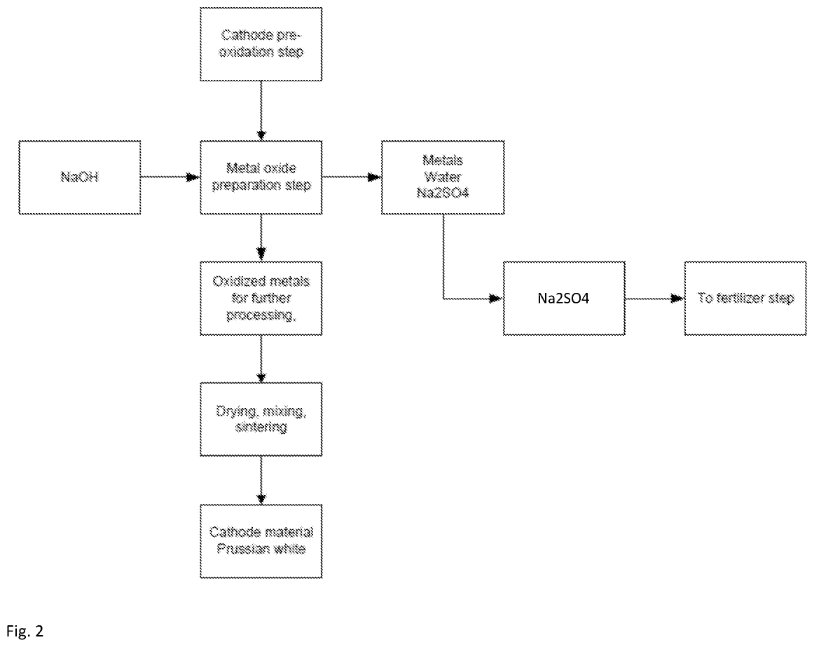

### DETAILED DESCRIPTION

The present invention relates to providing valuable components from residue process streams of sodium-iron battery production or from residue process streams of sodium-iron battery recycling.

The present method for producing a potassium sulfate containing fertilizer composition from a sodium sulfate containing residue process stream of a battery production process include the steps of:
the residue process stream being provided from the battery production process, wherein the residue process stream is being obtained from production of batteries comprising at least sodium and iron (Na, Fe);
optionally water is being provided;
potassium chloride is being provided; and
a mixture is being provided comprising said optional water, potassium chloride and residue process stream, and is allowed to react, wherein potassium sulfate is obtained. Optionally the batteries also include cyanide.

The present method for producing a potassium sulfate containing fertilizer composition from a sodium sulfate containing residue process stream of a battery recycling process include the steps of:
the residue process stream is being provided from the battery recycling process, wherein the residue process stream is being obtained from recycling of batteries comprising at least sodium and iron (Na, Fe);
optionally water is being provided;
potassium chloride is being provided; and
a mixture is being provided comprising said optional water, potassium chloride and residue process stream, and is allowed to react, wherein potassium sulfate is obtained. Optionally the batteries also include cyanide.

A residue process stream may be mixed with and at least partially dissolved in water. Preferably the residue process stream is a solution. Components of the residue process stream is preferably dissolved. The aqueous mixture of the residue process stream may optionally be treated with an acid, preferably sulfuric acid. The optional use of acid may depend on the composition of the residue process stream.

The residue process stream may vary in chemical content and can contain the following impurities: Na₂SO₄, sodium, calcium, lithium, aluminium, iron and manganese. Optionally a subsequent step of pH modification using an alkaline compound may be used, e.g., if the above-mentioned acid has been added in the process. Preferably KOH and/or NaOH are used as alkaline compounds. The addition of alkaline compound may be used to increase the pH and achieve a correct stoichiometric relation with regards to K₂SO₄ and NaCl.

Potassium chloride, KCl, is added to the aqueous mixture comprising the residue process stream in order to obtain potassium sulfate. The solid phase obtained in the process may comprise a salt called glaserite composed of potassium and sodium sulfate (K₃Na(SO₄)₂). In one embodiment the intermediate product obtained in the present process after the first addition of the potassium chloride is glaserite.

The obtained glaserite salt is removed from the treated residue process stream, the liquid remaining part of the mixture, and may be further treated with KCl in order to produce K₂SO₄. The obtained K₂SO₄ may thereafter be removed.

The reactions are for the production of the intermediate glaserite and the K₂SO₄ are disclosed below.

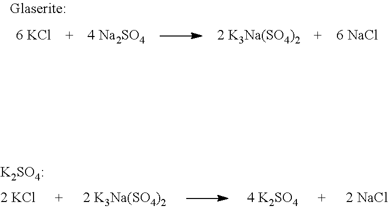

As an alternative processing, the obtained glaserite salt may after removal from the treated residue process stream be leached in water in order to provide K₂SO₄.

However, in a further embodiment, the present process may include a combination of both mentioned treatment steps for the glaserite, in any order. Then the obtained glaserite salt may first be treated with KCl and thereafter leached in water in order to produce K₂SO₄, or the other way around.

The potassium chloride used in the present process may be subjected to a pretreatment step including washing and optionally evaporation prior to addition to the residue process stream. Pretreatment by washing with water allows for removal of byproducts or impurities present. Potassium chloride products provided on the market often contains some byproducts or impurities, such as e.g. sodium chloride. By subjecting the potassium chloride to a water wash, any impurities present may be removed from the potassium chloride and thus improving the quality of the potassium chloride to be added to the residue process stream. By performing a pretreatment using a water wash, and optionally a subsequent evaporation of water, the quality of the potassium chloride may e.g., be improved from containing about 4 wt % sodium chloride to contain at most 1 wt % sodium chloride. Such an increase in purity of the potassium chloride used in the present process improves the yield of potassium sulfate obtained in the conversion step at least five times, when the conversion to potassium sulfate is performed at a pH of about 5-9, such as about 6 to 8, and preferably about 6-7.

The treated residue process stream remaining after the separation of K₂SO₄ may be further processed, e.g., via a cooling step in order to precipitate sodium sulfate and improve the yield of sulfates by returning said sulfates to the process.

The treated residue process stream remaining after the separation of K₂SO₄ may be further processed, e.g., via evaporation in order to precipitate sodium chloride (NaCl) which may be removed as a solid phase. This may then be used as e.g., road salt.

The present invention can further be complemented by the use of a membrane cell process which may convert the obtained NaCl into NaOH, H₂ and Cl₂. NaOH is a valuable chemical and used by a battery production and/or recycling plant. The two other products H₂ and Cl₂ may be collected and either used by as energy in the case of H2 or sold to third party to improve the economy and profitability of the battery process.

In this manner more value adding products than the fertilizer produced may be obtained and reused in the battery production process or other processes or sold.

1. A method for producing a potassium sulfate containing fertilizer composition from a sodium sulfate containing residue process stream of a battery production process or a battery recycling process, wherein the residue process stream is provided from the battery production process or the battery recycling process, wherein the residue process stream is obtained from production of batteries comprising at least sodium and iron (Na, Fe) or obtained from recycling of batteries comprising at least sodium and iron (Na, Fe);
optionally water is provided;
potassium chloride is provided; and
a mixture is provided comprising said optional water, potassium chloride and residue process stream, and is allowed to react, wherein potassium sulfate is obtained.

2. The method according to claim 1, wherein the residue process stream is obtained from production of batteries comprising sodium, iron and cyanide (Na, Fe, CN) or obtained from recycling of batteries comprising sodium, iron and cyanide (Na, Fe, CN).

3. The method according to claim 1, wherein the water, the potassium chloride and the residue process stream are mixed in any order or simultaneously to provide said mixture, preferably the water and residue process stream is added before the potassium chloride.

4. The method according to claim 1, wherein acid is admixed to the mixture, preferably before the addition of the potassium chloride.

5. The method according to claim 1, wherein the residue process stream has been pretreated in an evaporation step in order to produce a dry matter that is contacted with the water and thereafter is contacted with the potassium chloride.

6. The method according to claim 1, wherein sodium hydroxide and/or potassium hydroxide is added to the water, potassium chloride, and residue process stream mixture.

7. The method according to claim 1, wherein glaserite is obtained by the reaction of the water, the potassium chloride and the residue process stream, said glaserite is removed and admixed with additional potassium chloride and/or is leached with water to provide potassium sulfate.

8. The method according to claim 7, wherein the remaining mixture after removal of potassium sulfate is concentrated, whereafter any sodium chloride present is removed.

9. The method according to claim 8, wherein the removed sodium chloride is forwarded to a cell membrane process converting it to sodium hydroxide, hydrogen and chlorine.

10. The method according to claim 1, wherein the potassium chloride added to the residue process stream has been subjected to a pretreatment step including washing with water and optionally subsequent evaporation to remove any impurities present in the potassium chloride.

11. Use of the method according to claim 1 for the production of a fertilizer comprising potassium sulfate.
